(19) United States
(12) Patent Application Publication
(10) Pub. No.: US 2025/0122899 A1
(43) Pub. Date: Apr. 17, 2025

(54) Fastener and Installation Tool

(71) Applicant: Robert Rosebrugh, Oxnard, CA (US)

(72) Inventor: Robert Rosebrugh, Oxnard, CA (US)

(21) Appl. No.: 18/913,358

(22) Filed: Oct. 11, 2024

Related U.S. Application Data
(60) Provisional application No. 63/589,561, filed on Oct. 11, 2023.

(51) Int. Cl. F16B 13/08; B25B 13/48; F16B 13/00; F16B 37/04

(52) U.S. Cl. CPC F16B 13/0875; B25B 13/481; F16B 37/041; F16B 2013/007

(57) ABSTRACT

A fastener for mounting through an aperture of a wall, the aperture having an aperture diameter. The fastener has an inner stud sized to fit through the aperture of the wall, the inner stud having an externally threaded shank, and further having an internally threaded bore. A spiral structure operably connects with the inner stud. An installation tool comprises an elongate body that extends from a proximal end to an externally threaded distal end, wherein the distal end may threadedly engage the internally threaded bore of the inner stud. An outer nut has an inner conduit with an internal thread that may be threadedly engaged with the externally threaded shank of the inner stud. The installation tool further includes a spanner knob threadedly mounted on the elongate body, the spanner knob having a first engagement structure that removably engages a second engagement structure of the outer nut such that the spanner knob may be used to turn the outer nut with respect to the inner stud, and thereby threadedly tighten the outer nut on the inner stud, which functions to compress the spiral structure in a washer-like structure.

### CROSS-REFERENCE TO RELATED APPLICATIONS

This application for a utility patent claims the benefit of U.S. Provisional Application No. 63/589,561, filed Oct. 11, 2023.

### BACKGROUND OF THE INVENTION

### Field of the Invention

This invention relates generally to fasteners, and more particularly to blind fasteners.

### Description of Related Art

The prior art teaches a variety of blind fasteners for mounting objects to a wall through an aperture when the space behind the wall cannot be readily accessed.

A particularly strong blind fasteners is shown in Rosebrugh, U.S. Pat. No. 9,714,674, which teaches a blind fastener adapted to be mounted through an aperture of a wall. The blind fastener includes an inner stud having a spiral structure that may be inserted through the aperture in the wall, and an outer nut that is then fastened to the inner stud. However, since the inner stud must be inserted through the aperture, this type of blind fastener may be difficult to install, and there has been a need in the field for a tool that enables these types of blind fasteners to be installed quickly and easily.

The present invention fulfills all of the above-described needs, and provides other advantages, as detailed in the following summary.

### SUMMARY OF THE INVENTION

The present invention teaches certain benefits in construction and use which give rise to the objectives described below.

The present invention provides a fastener for mounting through an aperture of a wall, the aperture having an aperture diameter. The fastener comprises an inner stud sized to fit through the aperture of the wall, the inner stud having an externally threaded shank, and further having an internally threaded bore. A spiral structure operably connects with the inner stud. An installation tool comprises an elongate body that extends from a proximal end to an externally threaded distal end, wherein the distal end may threadedly engage the internally threaded bore of the inner stud. An outer nut has an inner conduit with an internal thread that may be threadedly engaged with the externally threaded shank of the inner stud. The installation tool further includes a spanner knob threadedly mounted on the elongate body, the spanner knob having a first engagement structure that removably engages a second engagement structure of the outer nut such that the spanner knob may be used to turn the outer nut with respect to the inner stud, and thereby threadedly tighten the outer nut on the inner stud, which functions to compress the spiral structure in a washer-like structure.

A primary objective of the present invention is to provide a fastener having advantages not taught by the prior art.

Another objective is to provide a fastener having an installation tool for installing a blind fastener assembly into an aperture of a wall.

Another objective is to provide an installation tool for quickly and easily installing a blind fastener through a wall.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention.

FIG. 1 is an exploded first perspective view of a fastener and installation tool according to one embodiment of the present invention;

FIG. 2 is an assembled second perspective view thereof;

FIG. 3 is a front elevation view thereof;

FIG. 4 is a rear elevation view thereof,

FIG. 5 is a top plan view thereof;

FIG. 6 is a bottom plan view thereof;

FIG. 7 is a left side elevation view thereof;

FIG. 8 is a right side elevation view thereof;

FIG. 9 is a first perspective view of a spanner knob of the fastener and installation tool;

FIG. 10 is a second perspective view thereof;

FIG. 11 is a front elevation view thereof;

FIG. 12 is a rear elevation view thereof;

FIG. 13 is a top plan view thereof;

FIG. 14 is a bottom plan view thereof;

FIG. 15 is a right side elevation view thereof;

FIG. 16 is a left side elevation view thereof;

FIG. 17 is a top perspective view of a spiral structure of a fastener assembly;

FIG. 18 is a bottom perspective view thereof;

FIG. 19 is a front elevation view thereof;

FIG. 20 is a rear elevation view thereof;

FIG. 21 is a top plan view thereof;

FIG. 22 is a bottom plan view thereof;

FIG. 23 is a left side elevation view thereof;

FIG. 24 is a right side elevation view thereof;

FIG. 25 is a perspective view of a fastener assembly being mounted on the installation tool; and

FIG. 26 is a section view of the fastener and installation tool installed in a wall.

### DETAILED DESCRIPTION OF THE INVENTION

The above-described drawing figures illustrate the invention, a fastener and installation tool that is used to install a fastener assembly through an aperture in a wall. This is particularly useful in situations where the back side of the wall cannot readily be accessed, and the installation must be made entirely through the aperture of the wall (aka, a “blind fastener”).

For the purposes of this application, the term “wall” is defined to include any surface to which an attachment is desired, such as a wall in a structure (e.g., the drywall or other portion of a wall or other construction within the structure), a vehicle having a wall that forms a part of the vehicle (e.g., the body or other structure of a truck, automobile, boat, aircraft, satellite, etc.), or any other structure which requires the use of a blind fastener.

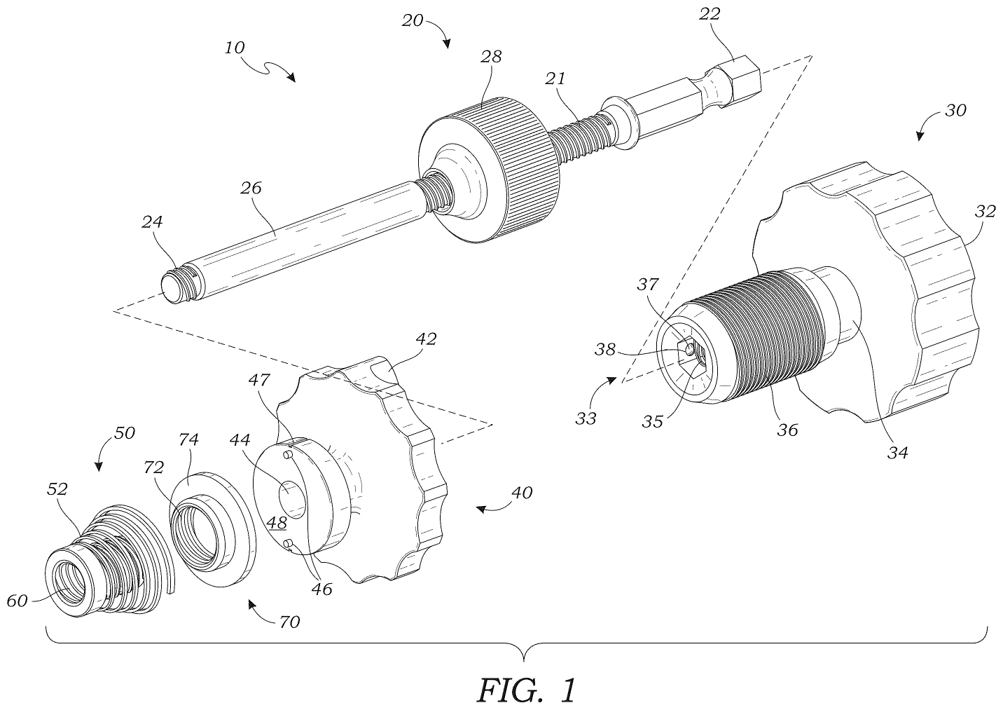

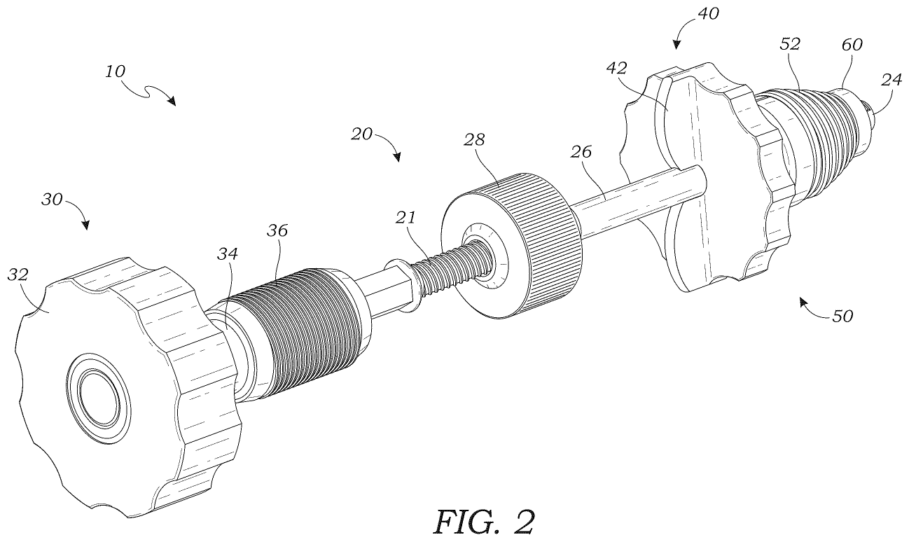

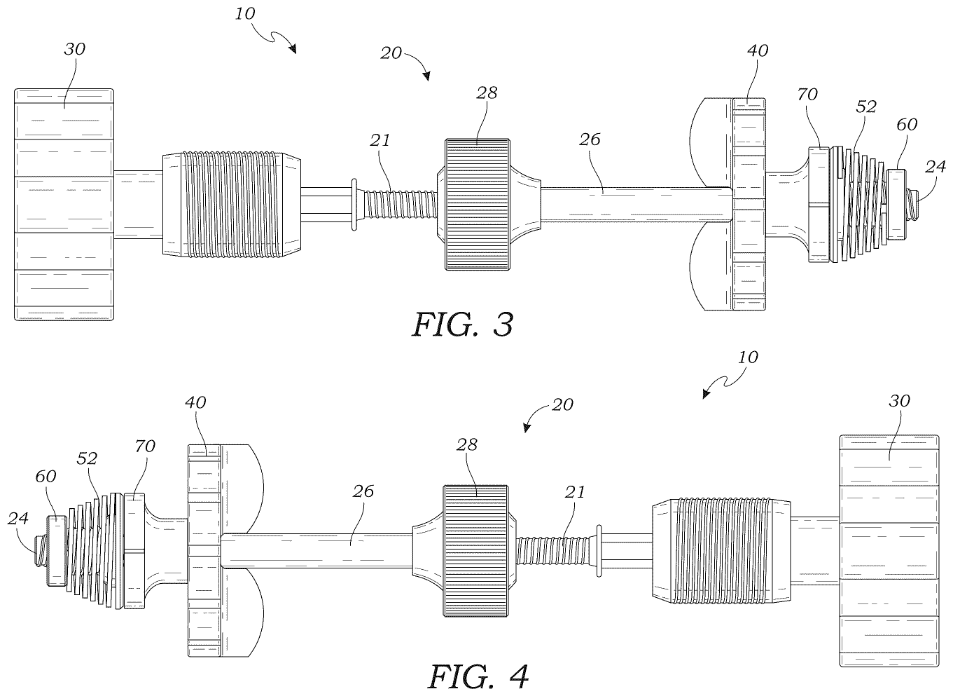

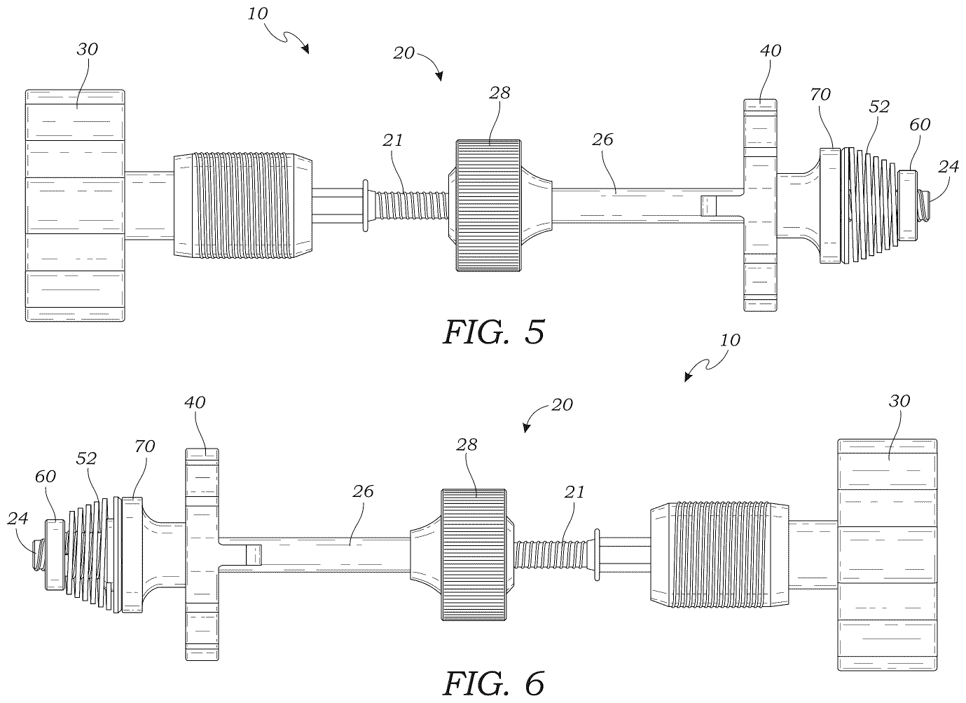

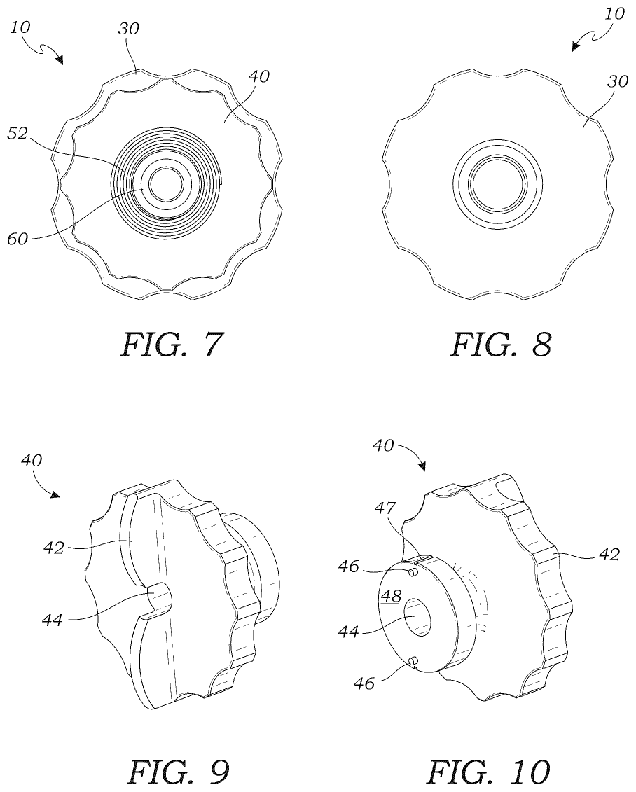

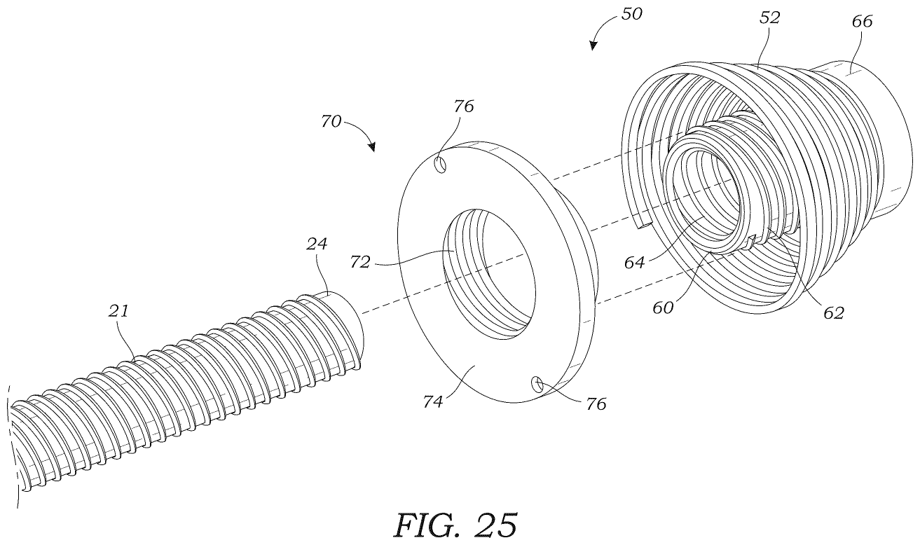

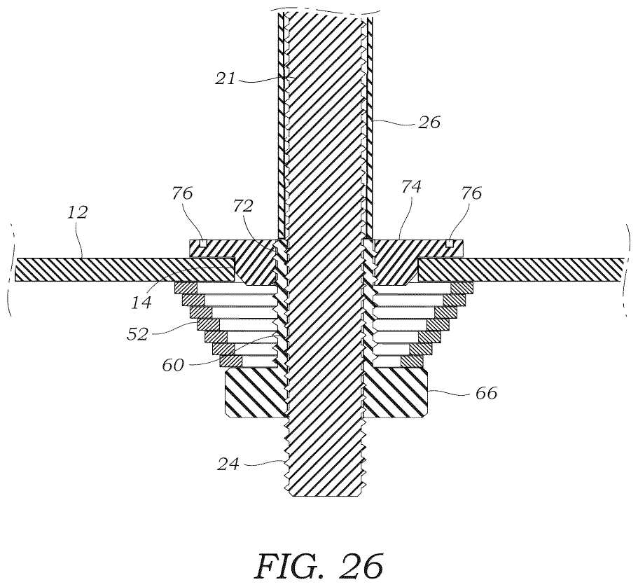

FIG. 1 is an exploded first perspective view of a fastener and installation tool 10 according to one embodiment of the present invention, and FIG. 2 is an assembled second perspective view thereof. FIGS. 3-8 are plan and elevation views thereof. FIG. 25 is a perspective view of the fastener assembly 50 being mounted on the externally threaded elongate body 21 of the installation tool 20, and FIG. 26 is a sectional view of the fastener assembly and installation tool 10 installed in a wall 12 via the installation tool 20 via a fastener assembly 50.

As shown in FIGS. 1-8, 25 and 26, in this embodiment the installation tool 20 includes an elongate body 21 having a proximal end 22 and a distal end 24, the elongate body 21 being in the form of an externally threaded rod. The rod 21 of this embodiment is rigid (e.g., steel, rigid plastic, etc.). The distal end 24 is adapted for removable engagement with the fastener assembly 50, discussed further below.

The fastener assembly 50 includes an outer nut 70 adapted for installation over an aperture 14 of the wall 12 (as shown in FIG. 26). The outer nut 70 includes an internally threaded shaft 72 for threaded mounting on an inner stud 60, and an outwardly extending flange 74. Further details of the fastener assembly 50 are discussed below.

As shown in FIGS. 1-6, a locking tube 26 is positioned around the elongate body 21 (aka, threaded rod of installation tool 20) for abutting the inner stud 60, to hold it in place, and the locking tube 26 is held in place (adjustably) with a tension knob 28 that is threadedly mounted on the elongate body 21.

A top knob 30 is also mounted on the elongate body 21. As illustrated, the top knob 30 is mounted on the proximal end 22 of the elongate body 21, and may include a grip portion 32 with an elongate shaft 34 extending therefrom. The top knob 30 may be fixedly or integrally mounted on the elongate body 21, or it may be removable. The elongate shaft 34 of the top knob 30 may have an inner bore 35 for receiving the proximal end 22 of the elongate shaft 34. The inner bore 35 may be shaped to compliment the shape of the proximal end 22, so the top knob 30 may be used to turn the rest of the installation tool 20 once engaged.

In this embodiment, the proximal end 22 is in the form of a hex shank quick release, and the elongate shaft 34 of the top knob 30 includes an interlocking mechanism that enables it to be mounted on the hex shank quick release. In this embodiment, the interlocking mechanism 33 is in the form of a release sleeve 36 mounted on the elongate shaft 34, the release sleeve 36 including inner ball bearings 37 that bias into holes 38 of the elongate shaft 34. In this manner, the release sleeve 36 may be slid so that the ball bearings 37 bias into the holes 38 and hold the proximal end 22 of the elongate body 21 in place. To release, the user simply slides the release sleeve 36 toward the grip portion 32 to pull the ball bearings 37 out of the holes 38 so that the proximal end 22 is no longer held in place. The top knob 30 may be provided to assist with twisting the installation tool 20 to install the fastener assembly 50. Alternatively, the proximal end 22 may be inserted into a drill (not shown) for installation.

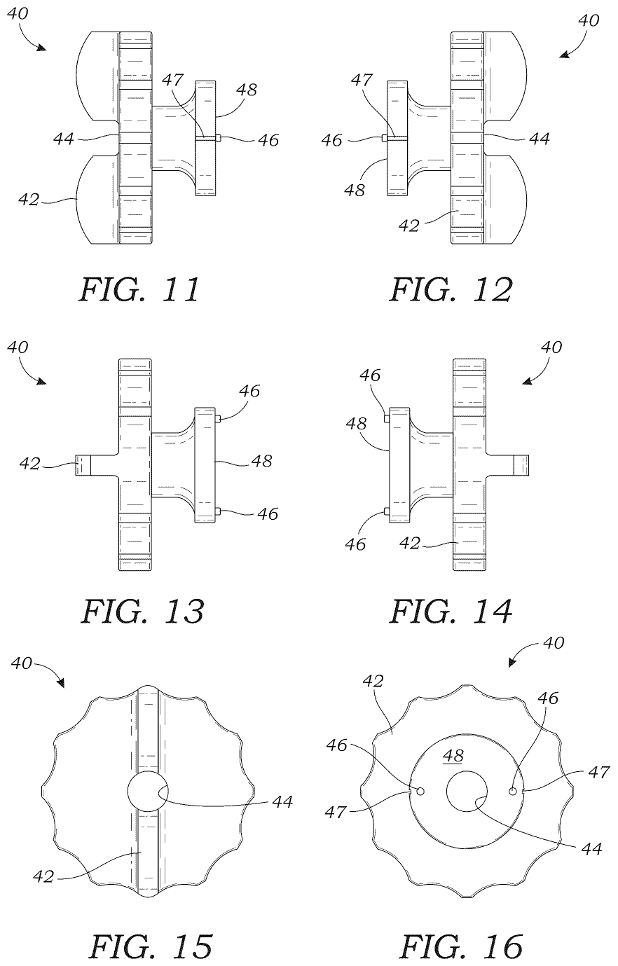

FIGS. 9-16 are different views of a spanner knob 40 that is also included in one embodiment of the installation tool 20. As shown in FIGS. 1-7 and 9-16, the spanner knob 40 is mounted adjacent the distal end 24 of the elongate body 21, positioned over the locking tube 26 for engaging with the outer nut 70. The spanner knob 40 may include a grip portion 42 and an inner bore 44 for receiving the distal end 24 of the elongate body 21, and also the locking tube 26, the grip portion 42 having a bottom surface 48 with a first engagement structure 46 for engaging a second engagement structure 76 in the outer nut 70 (FIGS. 25-26) so that the spanner knob 40 may be used to turn the outer nut 70 for tightening the fastener assembly 50, as discussed below.

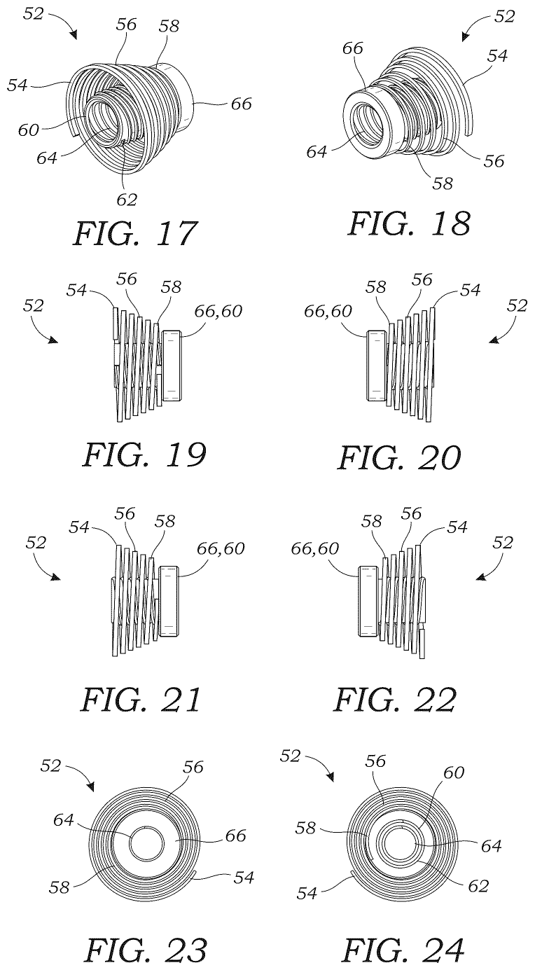

FIGS. 17 and 18 are perspective views of a spiral structure 52 and the inner stud 60 of the fastener assembly 50, and FIGS. 19-24 are various elevation views thereof. As shown in FIGS. 17-24, the fastener assembly 50 includes the inner stud 60 sized to fit through the aperture 14 of the wall 12, the inner stud 60 having an externally threaded shank 62, and further having an internally threaded bore 64. In this embodiment, the spiral structure 52 is attached to a head 66 of the inner stud 60 (e.g., welded, bonded, adhered, or otherwise attached), the spiral structure 52 being constructed of a bendable material, in this case a resilient material (e.g., spring steel, or other suitable material). The external threads of the installation tool 20 spiral in a direction that is opposite of the threads of the externally threaded shank 62 of the inner stud 60. The spanner knob 40 may be used to turn the outer nut 70 with respect to the inner stud 60 for tightening the fastener assembly 50, as discussed further below.

In this embodiment, the spiral structure 52 may be in the form of a spiral spring that includes a first end 54 having a larger diameter that is larger than the aperture 14 in the wall 12, a middle section 56 which spirals inwardly to smaller diameters to a second end 58 which is attached to the head 66 of the inner stud 60. The second end 58 has a diameter which is smaller than the diameter of the aperture 14, thereby allowing it to be inserted through the aperture 14. By twisting the spiral structure 52, all of the structure 52 may be fed through the aperture 14 to get the structure entirely through the aperture 14. The spiral structure 52 may be constructed of a variety of materials, such as a spring steel, a suitable plastic, or other materials known in the art having suitable strength and flexibility suitable for this function.

FIG. 25 is a perspective view of the fastener assembly 50 being mounted on the externally threaded elongate body 21 of the installation tool 20, and FIG. 26 is a sectional view of the fastener assembly and installation tool 10 installed in the wall 12. As shown in FIGS. 1-26, in use, the fastener assembly 50 may be installed into the aperture 14 of the wall 12 for hanging or supporting an attachment item (not shown). At a first step of installation, the tension knob 28 is twisted to press the locking tube 26 against the shank 62 of the inner stud 60, thereby locking the inner stud 60 in place. A user may use the installation tool 20 to insert the inner stud 60 (and spiral structure 52) through the aperture 14. By twisting the installation tool 20, the spiral structure 52 of the fastener assembly 50 may be fed through the aperture 14 of the wall 12 until all of the structure 52 is on the inner side of the wall 12. The spiral structure 52 is then pulled against the wall 12 via the installation tool 20, so that the spiral structure 52 is flattened to form a washer-like structure behind the wall 12. The outer nut 70 is then threadedly mounted on the inner stud 60, on the external threads of the shank 62 of the inner stud 60, so that the fastener assembly 50 is secured on the wall 12, as shown in FIG. 26.

As illustrated, the flange 74 of the outer nut 70 is larger in diameter than the aperture 12 of the wall, the flange having the internally threaded shaft 72 extending therefrom, wherein the externally threaded shaft 72 is smaller in diameter than the aperture 14 of the wall 12, and is sized to threadedly engage the internally threaded bore 64 of the inner stud 60.

The flange 74 may include the second engagement structure 76, in this embodiment in the form of two or more bores which enable engagement of the first engagement structure 46 of the spanner knob 40, in this embodiment in the form of at least one post (in this embodiment, a pair of posts), for turning the outer nut 70. In some embodiments, a groove 47 is formed adjacent each post, so that a user can identify its location for easier alignment. Alternative engagement structures may also be implemented, e.g., other forms of protrusions, a claw edge, magnets, clips, etc., and these alternatives should be considered within the scope of the present invention.

The internally threaded shaft 72 of the outer nut 70 may have a diameter that is larger than the shank 62 of the inner stud 60, so it may engage with the external threads. While one embodiment of the outer nut 70 is shown, alternative structures may be implemented. Once tightened, the spanner knob 40 can be retracted from the outer nut 70, and the installation tool 20 may be removed while the fastener assembly 50 stays mounted on the wall 12.

Once the fastener assembly 50 is tightened, it may be used to hold an item (not shown) securely in place on the wall 12. The spiral structure 52 forms a washer behind the wall, providing superior strength.

In some uses, at a final step of installation, once the spiral structure 52 has been twisted through the aperture 14, the outer nut 70 may be used to mount the item. In another embodiment (not illustrated), the user may mount the fastener assembly 50 without the attachment item, and after installation the attachment item may be fastened to the outer nut 70, or other suitable structure. The attachment item may be any item or structure that one might with to mount to a wall, such as but not limited to picture frames or a form of frame-hanging mechanism, or other item that one might mount to the wall of a home or other building, a loop for attaching various types of lines, any structure that the user may want to mount on a wall of a vehicle, such as to an automobile, truck, RV, boat, etc. The number of items which can be mounted is without limit except for the imagination of the user.

The title of the present application, and the claims presented, do not limit what may be claimed in the future, based upon and supported by the present application. Furthermore, any features shown in any of the drawings may be combined with any features from any other drawings to form an invention which may be claimed.

As used in this application, the words “a,” “an,” and “one” are defined to include one or more of the referenced item unless specifically stated otherwise. The terms “approximately” and “about” are defined to mean+/−10%, unless otherwise stated. Also, the terms “have,” “include,” “contain,” and similar terms are defined to mean “comprising” unless specifically stated otherwise. Furthermore, the terminology used in the specification provided above is hereby defined to include similar and/or equivalent terms, and/or alternative embodiments that would be considered obvious to one skilled in the art given the teachings of the present patent application. While the invention has been described with reference to at least one particular embodiment, it is to be clearly understood that the invention is not limited to these embodiments, but rather the scope of the invention is defined by claims made to the invention.

What is claimed is:

1. A fastener for mounting through an aperture of a wall, the aperture having an aperture diameter, the fastener comprising:
an inner stud sized to fit through the aperture of the wall, the inner stud having an externally threaded shank, and further having an internally threaded bore;
a spiral structure operably connected with the inner stud;
an installation tool comprising an elongate body that extends from a proximal end to an externally threaded distal end, wherein the distal end may threadedly engage the internally threaded bore of the inner stud;
an outer nut having an inner conduit that has an internal thread that may be threadedly engaged with the externally threaded shank of the inner stud; and
the installation tool further comprising a spanner knob threadedly mounted on the elongate body, the spanner knob having a first engagement structure that removably engages a second engagement structure of the outer nut such that the spanner knob may be used to turn the outer nut with respect to the inner stud, and thereby threadedly tighten the outer nut on the inner stud, which functions to compress the spiral structure in a washer-like structure.

2. The fastener of claim 1, further comprising a locking tube positioned around the elongate body for abutting the inner stud, wherein the locking tube is held in place with a tension knob that is threadedly mounted on the elongate body.

3. The fastener of claim 1, wherein the spanner knob includes a grip portion and an inner bore for receiving the distal end of the elongate body therethrough.

4. The fastener of claim 3, wherein the grip portion includes a first engagement structure that removably engages a second engagement structure of the outer nut such that the spanner knob may be used to turn the outer nut with respect to the inner stud, and thereby threadedly tighten the outer nut on the inner stud, which functions to compress the spiral structure in a washer-like structure.

5. The spanner knob of claim 1, wherein the proximal end of the elongate body is in the form of a hex shank quick release, wherein a top knob includes an interlocking mechanism that enables it to be mounted on the hex shank quick release of the proximal end of the elongate body.

6. The fastener of claim 1, wherein the external threads of the installation tool spiral in a direction that is opposite of the threads of the externally threaded shank of the inner stud.
